(19) United States
(12) Patent Application Publication
(10) Pub. No.: US 2015/0191383 A1
(43) Pub. Date: Jul. 9, 2015

(54) SUBMERGED FILTRATION SYSTEM AND WASTEWATER TREATMENT METHOD

(71) Applicant: Burcu Didem OZDEMÌR YILDIZ, Istanbul (TR)

(72) Inventor: Burcu Didem Ozdemir Yildiz, Istanbul (TR)

(21) Appl. No.: 14/417,417

(22) PCT Filed: Jul. 15, 2013
(86) PCT No.: PCT/TR2013/000217

§ 371 Date: Jan. 26, 2015

(30) Foreign Application Priority Data
Jul. 27, 2012 (TR) 2012/08804

(51) Int. Cl. C02F 3/06; C02F 3/20; B01D 37/02; B01D 39/08

(52) U.S. Cl. CPC C02F 3/06; B01D 39/083; C02F 3/20; B01D 37/02; C02F 2203/006; C02F 2303/20

(57) ABSTRACT

A submerged filter system which separates the activated sludge and the permeate in the waste water with the cake filtration method by being adapted into a bioreactor in a submerged position. The submerged filter system has at least one filter group that has a sludge cake layer, which separates the active sludge and the permeate physically, and a cloth filter which contributes to the filtration process by harboring the formation of the said sludge cake. A wastewater treatment method employing the filter system is also disclosed.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The invention is related with a kind of a submerged filter system that will be used for separating the activated sludge and treated wastewater (permeate), in the area of wastewater treatment with the activated sludge technique.

2. Description of Related Art Including Information Disclosed Under 37 CFR 1.97 and 37 CFR 1.98.

In some of the existing systems in the area of wastewater treatment, filtration has been used after treatment processes of all configurations, which have been operated at high biomass concentrations for conventional carbon removal, nitrification, denitrification and/or biological phosphorus removal. The processes, whereof, which combine the activated sludge and filtration, are called membrane bioreactors (MBR).

Activated sludge systems that are operated at high biomass concentrations are currently used. Thus, high biomass systems may reduce both operation and construction costs due to low sludge production, accordingly low sludge processing and ultimate disposal costs, and due to their capability of efficient treatment with lower process tank volumes etc. Furthermore, in contrary to conventional systems, the sludge floes (MLSS, roughly active biomass+inert material) produced at high biomass concentration and high sludge age (biomass retention time in system) systems, cannot be separated from treated wastewater by gravity settling because of their nature and filtration becomes a necessity for these systems.

The cost of membrane units has been decreasing gradually especially in the last ten years. However, in comparison with the systems that the treated wastewater is separated from biomass in a conventional settling tank, the inclusion of membrane filtration into activated sludge systems is still quite expensive.

Besides, membrane fouling by time is also a concern in existing membrane bioreactors (MBR). Hence, filtration efficiency (sustainability of filtration flux), thereby the treated wastewater volume to be filtered throughout a particular filter area declines by time. These fouling problems are caused by many mechanisms like: plugging of pore entrances by activated sludge content and prevention of any flow through pores, particle accumulation inside the membrane on the pore walls, plugging of pore entrances by a fraction of particles and a deposition of the rest on top of them, accumulation of particles at the surface in a permeable cake of increasing thickness. In some cases, one or more mechanism may occur back to back.

Some techniques like surface scouring by air in submerged filter systems, backwashing of external filter units, providing a cross flow across the filter have been applied to prevent fouling and achieve sustainable filtration. However, it is not possible to preclude entirely the fouling problem during operation. Hence, in addition to routine—daily or continuous precautions to avoid fouling, membrane bioreactors (MBR) require to be backwashed chemically at longer periods in an operating cycle like 3 or 6 months. On the other hand, the fouling problem increases with increasing sludge concentration in the system. Therefore, the MLSS concentration for full-scale plant design and application is chosen as 12000-15000 mg/L and the activated sludge systems are operated at these concentrations. The increase in the concentration of sludge means higher operation and construction cost; higher energy consumption for fouling precautions like air scouring, cross flow pumping, backwashing and higher chemical consumption. Meanwhile fouling constricts membrane material's original pore size, it is also a factor that improves the filtered water quality, because filtration is a physical process that depends on particulate size and permeability of filter material. However, as it is mentioned above, the fouling occurs in existing membrane bioreactor (MBR) systems as a problem needs to be prevented in order to provide sustainable filtration.

As a result, because of the above mentioned problems, an improvement is required in the technical field of concern.

### BRIEF SUMMARY OF THE INVENTION

The invention is related to a new submerged filter system that will be used for separation of treated wastewater (permeate) from activated sludge and also aims to remove the above mentioned disadvantages and to bring new advantages to the technical field of concern.

The main objective of the invention is to bring up a submerged filter system that achieves separation of treated wastewater (permeate) from activated sludge by filtration depends on cake filtration principles.

Another objective of the invention is to bring up a submerged filter system that does not cause fouling problem. The system is a cake filtration system that uses the activated sludge as a ‘filter’; instead of preventing, it allows the formation of the cake layer, which causes fouling, on the surface and within the pores of filter material.

The invention is related to a submerged filter system that is mounted submerged in a bioreactor and provides separation of permeate water from activated sludge by cake filtration method in order to achieve all of the objectives mentioned above and below described in detail. The feature of the submerged filter is characterized by at least one filter group comprises of an activated sludge cake layer that provides the physical separation of activated sludge and permeate water, and a cloth filter that supports the cake layer to grow on it.

One preferred configuration of the invention comprises of at least one filter support pipe that supports all elements of the filter group.

Another preferred configuration of the invention comprises of holes on the support pipe, through which the permeate water is collected and forwarded to discharge pipe.

Another preferred configuration of the invention comprises of at least one permeate water group that provides the discharge of permeate water obtained during filtration in the filter group.

Another preferred configuration of the invention comprises of at least one permeate water pipe in the permeate water group connected to the support pipe to provide the discharge of filtered water.

Another preferred configuration of the invention comprises of at least one electrically actuated motorized valve mounted on the permeate water valve to control the flow in the permeate water line.

Another preferred configuration of the invention comprises of at least one flowmeter that controls the flow of permeate water.

Another preferred configuration of the invention comprises of at least one pressure transmitter that measures the pressure in the permeate water line.

Another preferred configuration of the invention comprises of at least one manual valve that provides to open and close the permeate water line.

Another preferred configuration of the invention comprises of at least one aeration group in order for the cake thickness to remain in balance and to provide the oxygen requirement for biological activity in bioreactor.

Another preferred configuration of the invention comprises of at least one blower pipe that allows transferring the air discharged from blower to diffusers.

Another preferred configuration of the invention comprises of air holes on diffusers in order for the cake layer to remain in desired thickness.

Another preferred configuration of the invention comprises of at least one diffuser pipe that allows the distribution of air from blower inside the filtration tank.

Another preferred configuration of the invention comprises of at least one support material that holds the filter group and the aeration group connected.

In another preferred configuration of the invention, the cloth filter is made up of polyester material.

The invention is related to a wastewater treatment method by a submerged filter system that is mounted submerged in a bioreactor and provides separation of permeate water from activated sludge by filtration method in order to achieve all of the objectives mentioned above and all further objectives, which will arise from detailed description below. Features of the method are characterized by following steps;
a Start-up of air flow through diffuser holes,
b Opening of motorized valve and manual valve,
c Contact of activated sludge and cloth filter, and beginning of particle accumulation inside the filter pores and on the pore walls,
d Formation of sludge cake as a result of activated sludge accumulation on the filter by time,
e Simultaneous biological treatment of wastewater,
f Obtaining permeate water (treated wastewater) of desired quality as a result of filtration through the cake layer.

In another preferred configuration of the invention, above mentioned “initiation of aeration through the air holes (132)” and “opening of motorized valve (111) and the manual valve (114)” steps may be realized simultaneously.

In order for better understanding of configuration and advantages of the existing invention along with its additional items, they should be evaluated together with the figures described below.

### BRIEF DESCRIPTION OF THE DRAWINGS

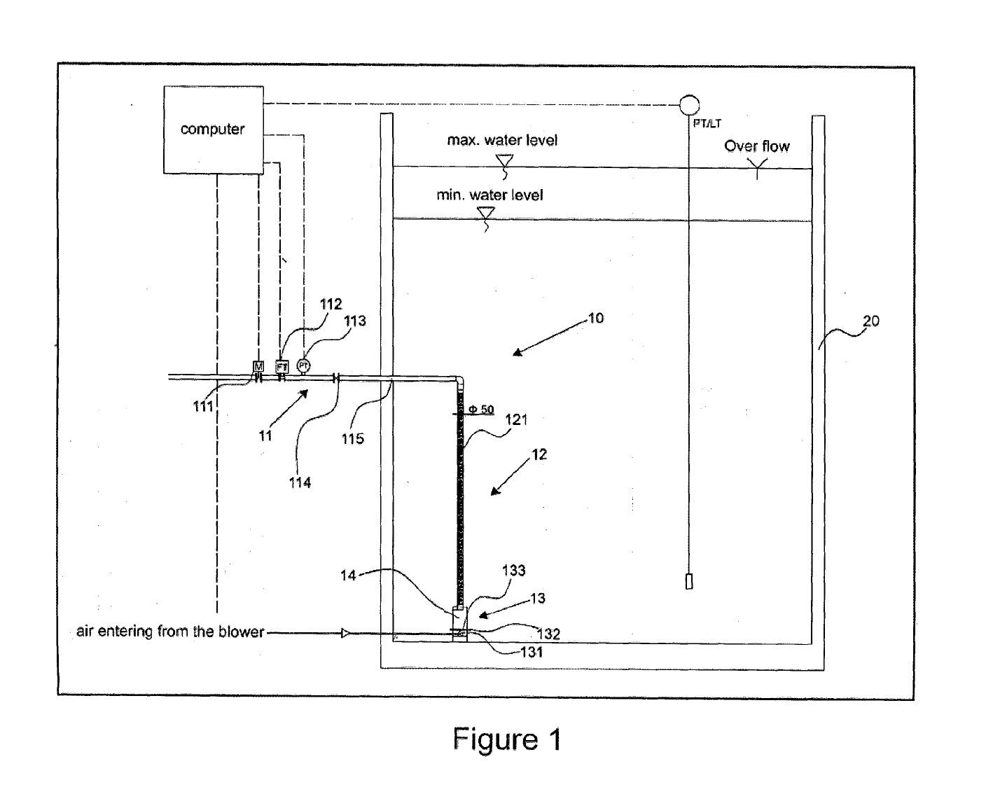

A general overview of submerged filter system is given in FIG. 1.

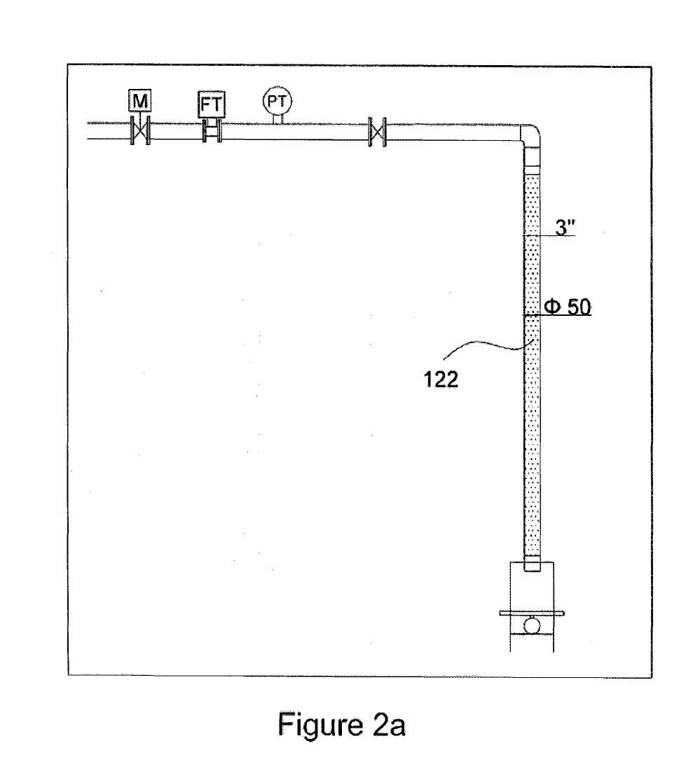

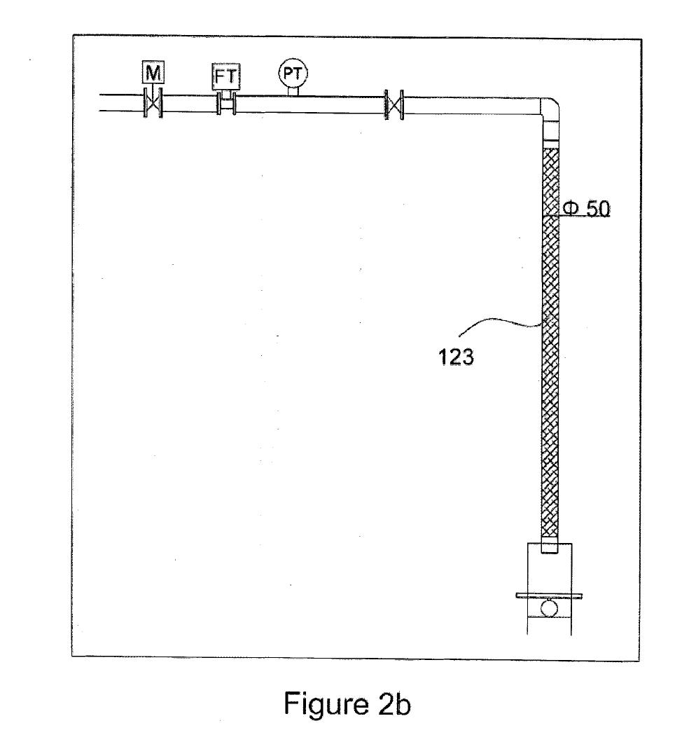

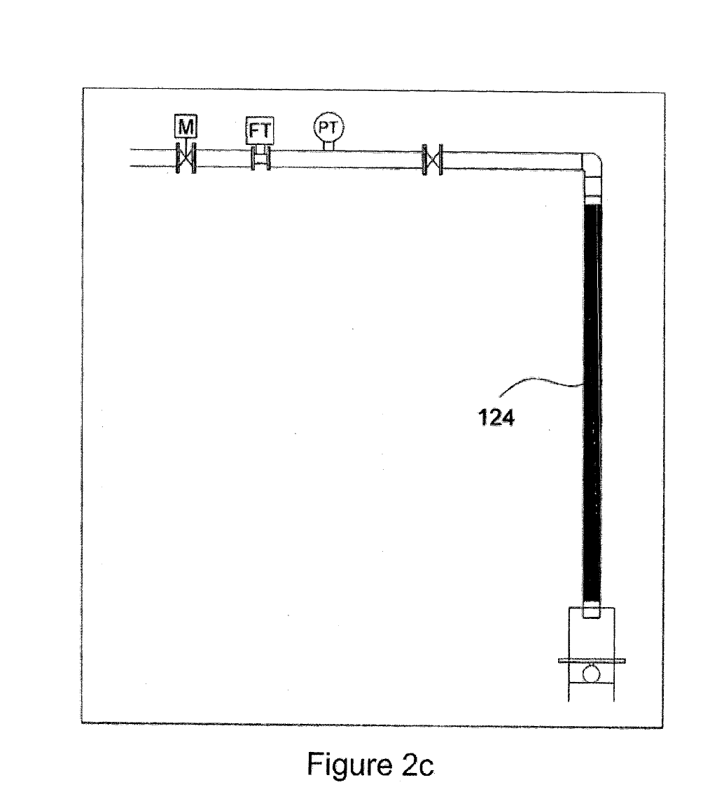

General overviews of the submerged filter system at different steps of separation of treated wastewater are given in FIGS. 2a, 2b and 2c.

### REFERENCE NUMBERS

10 Submerged Filter System
   11 Permeate Water Group
      111 Electrically Actuated Motorized Valve
      12 Flowmeter
      113 Pressure Transmitter/Instrument
      114 Manual Valve
      115 Permeate Water Pipe
   12 Filter Group
      121 Filter Support Pipe
      122 Holes
      123 Cloth Filter
      124 Sludge Cake
   13 Aeration Group
      131 Blower Pipe
      132 Air Hole
      133 Diffuser Pipe
      14 Support Material
20 Bioreactor

### DETAILED DESCRIPTION OF THE INVENTION

In this detailed description, the submerged filter (10), which is the subject of the invention, is explained by examples that will not limit the invention and will help to better understanding of the task. So, in the description and figures below, the submerged filter system (10) in topic is explained as adapted to a bioreactor (20) in a standard wastewater treatment system. However, the invention can also be adapted to different treatment systems with minor revisions on it.

A general view of the submerged filter system (10) used in wastewater treatment by adapting it to a bioreactor (20) for filtration process in order to separate the activated sludge and treated wastewater, which is also called as permeate water, is given in FIG. 1. First of all, a support material (14) is placed at the bottom of the reactor. A permeate water group (11), a filter group (12) and an aeration group (13) are mounted on the said support material (14). The support material (14) serves as a reinforcement that provides the filter group (12) and the aeration group (13) to stand together.

General views of the submerged filter system (10) during the different steps of separation of wastewater are given in FIGS. 2a, 2b and 2c. The permeate water group (11) comprises of an electrically actuated motorize valve (111), a flowmeter (112) and a pressure transmitter (113) that are controlled by a computer system, a manual valve (114) and a permeate water pipe (115). The said permeate water pipe (115) bears the rest of the permeate water group (11) elements and also discharges the treated and filtered water. The said motorized valve (111) opens and closes the permeate water line with an automatic control. Additionally, if required, the motorized valve (111) may be opened in different ratios and thus, the flowrate of the permeate water can be controlled. Furthermore, in case of a possible power cut, the motorized valve (111), which can be operated by being connected to UPS, shuts down the line automatically and prevents uncontrolled filtration. At the continuation of the motorized valve (111), the said flowmeter (112) is located which is adapted to the permeate water valve (115). Thus, the instant, hourly and daily flow rate of the permeate water can be recorded by the virtue of the flow meter (112). By following up the flow rate, the filtered pollution load, the change in the amount of the filtered water can be detected and depending on these data, operation strategies can be developed and applied. In addition to the flow rate follow up, the pressure measurement in the permeate water line is of vital importance for the filtering system. In order to make these measurements the said pressure gauge is used (113). The related pressure changes, pressure differences and values like these, which are followed up by the pressure gauge (113), is recorded in a computer. The said manual valve (114) located at the continuation of the pressure gauge (113) provides an opportunity for the maintenance and repair of the said units when necessary by closing the permeate water line. In addition to this, the manual valve (114) also serves as the replacement of the motorized valve (111).

The filter group (12) is adapted to the continuation (115) of the permeate water pipe which bears the permeate water group (11) elements. At least one filter support pipe (121) is connected to the continuation of the permeate water pipe (115). The said filter support pipe (121) serves as a supporting element of the filter group (12) by bearing the other elements of the filter group (12). In addition to this, the support pipe (121) is preferably made of HDPE material and preferably have an average dimension of 2 m. However, the said material and the dimensions may vary depending on the system necessities. Multiple number of holes (122) are provided on the filter support pipe (121). The said holes are used (122) to collect the water filtered through the system and to transfer it to the permeate water line. Preferably, there are 314 holes (122) on the filter support pipe (121) with a diameter of 0.3″. However, dimension and number of the said holes (122) may vary depending on the system necessities. At least one cloth filter (123) is adapted in such a way to be located on the filter support pipe (121). The said cloth filter (123) is preferably made of polyester fabric and has a pore size of 15-40 μm and has a filter area of 0.36 m². However, depending on the system necessities, the structural features of the cloth filter (123) may vary a little bit without affecting the functional characteristics. Beginning from the pores of the cloth filter (123) a layer forms thereon and this layer is called sludge cake (124). The said sludge cake (124) replaces the prior art filter material and carries out the essential filtration process. In prior art, the said sludge cake (124) was the unwanted (prevented or removed part) part due to fouling problems; however, in the present invention, the said sludge cake (124) is advantageously used in place of the filter.

At the continuation of the filter support pipe (121), near the bioreactor (20) basement, the aeration group (13) is located, in such a way that the support material (14) will remain between them. In the aeration group (13), at least one blower pipe (131) is present which conveys the air taken from a blower outside the bioreactor (20) to the diffusers present under the filter group (12). At the continuation of the said blower pipe (131), an air hole (132) lies which is used for keeping the sludge cake (124) formed on the cloth filter (123) at a desired thickness and at a specific equilibrium. On the other hand, at the continuation of the said air hole (132), at least one diffuser pipe (133) lies, which distributes the air taken from the blower into the tank in the from of air bubbles having specific dimensions. The air delivered from the said diffuser pipe (133) and air hole (132) into the tank provides the suspended-growth biological activity in the bioreactor (20) and the treatment.

In a detailed description, the submerged filter system (10) operates submerged in the activated sludge (biomass) having a concentration of 1.5-2.5% within the bioreactor (20). In the first step, the submerged filter system (10) is put in use and aeration from the air holes (132) begins and the motorized valve (111) with the manual valve (14) present on the permeate water line are opened simultaneously. When the sludge contacts with the cloth filter (123), the sludge starts to accumulate on and around the pores of the cloth filter (123). Afterwards, the sludge layer accumulated on the cloth filter (123) in time forms the sludge cake (124). As a result of the formation of the sludge cake (124) layer in a few minutes, the permeate water (treated waster water) is obtained in a desired quality, it moves through the permeate water pipe (115) and thus, the process of separating the treated permeate water from the activated sludge is accomplished.

The waste water treatment process mentioned above is realized in the bioreactor (20) with the activated sludge technique. The sludge cake (124) accumulated on the cloth filter (123) functions only for physical separation. This sludge cake (124) is just an activated sludge and no excipient is used in the cake formation. The filtered water is collected from the holes and discharged by the permeate water group (111) at the permeate water line. As a result of the air holes (132) located at a specific distance to the filtergroup (2) and the movement of the air bubbles (perpendicular to the flowing direction of the permeate) coming out of these air holes, the matured sludge cake (124) layer is kept at a specific thickness. However, at the beginning (during the entrance of the activated sludge (123) into the pores and the formation of the sludge cake (124)) this air effect has no impact due to the distance it has been located. Thus, in the first minutes after the initiation of the operation of the submerged filter system (10), a sludge cake (124) layer having an adequate thickness for the filtration is obtained. In here, also the oxygen needed for the biological treatment is obtained by the air flow provided by the aeration group (13). Once it reaches to the equilibrium conditions, the submerged filter system (10) operates for a long time without any need for a mechanic and/or chemical cleaning process or a backwashing system, thanks to its structure which turns the fouling factor into an advantage.

Based on the things described above, it can be seen that, in the submerged filter system (10), the holes (122) provided on the filter support pipe (121), the cloth filter (123) and the sludge cake (124) act as a filter system together. Although the real filtration is done by the sludge cake (124), the other elements are also important as they provide the formation of sludge cake (124) layer. Based on the laboratory and pilot scaled studies done with the proposed submerged filter system (10), it is observed that, less than 5 minutes is needed for the formation of the choking of the cloth filter (123) holes and the formation of sludge cake (124) layer on it. Namely, five minutes after the initiation of the process, the filter system composed of the cloth filter (123) and the sludge cake (124) reaches to a capacity of <10 mg/L sludge water. Therefore, the sludge cake (124) layer formed on the cloth filter (123) acts as a filter and designed as a practically constructable and manageable system.

In this context, the most important feature of the submerged filter system (10) is that, it can be operated in a stable way by converting the disadvantage of fouling into advantage. As mentioned above, by using the fouling feature, the activated sludge cake (124) is formed and filtration process is executed with this sludge cake (124). This is the most important difference of the proposed submerged filter system (10) from the prior art systems. In addition to this, the cloth filter (123) used in the claimed submerged filter system (10) is not a specially manufactured filter like the microfiltration or ultrafiltration membrane filters or is not a special material whose source and modulation needs precision. Therefore, the investment cost of the unit prepared with the cloth filter (123) is just 10% of the investment cost of the prior art systems.

In addition to these, the presence of the permeate water group (11) and the aeration group (13) in addition to the filter group (12) provides big advantages in terms of the continuity of the process in the submerged filter system (10). As the filtration process is executed by the 1.5-2 m water head (applied pressure) present on the filter group (12), no extra energy is needed for the filtration. If the advantages provided by the permeate water group (11) is evaluated, as said before, by continuously controlling the permeate water flow rate by the motorized valve (111), the permeate water flow rate can be adjusted at the desired interval according to the capacity of the submerged filter system (10). Furthermore, the trans-filter pressure of the submerged filter system (10) is followed up by the difference between the water head in the tank and the line pressure of the permeate water. The pressure difference which is low at the beginning decreases as the sludge cake (124) layer on the cloth filter (123) matures and it becomes stable at a specific level as the sludge cake (24) reaches to the equilibrium conditions. Thus, the permeate water may be obtained with a constant yield during the filtration. As the cloth filter (123) is saturated with the activated sludge and as the filtering process is performed with the equilibrium sludge cake (124) on it, the filtering performance is kept constant, and consequently, the submerged filter system (10) keeps on working with the same capacity independent from the increases and decreases in the activated sludge concentration in which it operates submerged.

Different from the prior art systems, by the virtue of the said aeration group (13) according to the present invention, a long term filtration is provided, not by preventing the fouling on the filter material (membrane) and on its holes, but by keeping the sludge cake (124) at a specific thickness. Therefore, the permeate water is obtained without a decrease for a long time (about two years) unlike the prior art systems which are needed to be cleaned at least once or twice a year.

As it is understood from the description above, the assembly of the submerged filter system (10) proposed in the present invention is simple and cheap and besides that, it does not need any mechanical and/or chemical periodic cleaning as it is the case in the prior art systems. To sum up, the submerged filter system (10) proposed with the invention operates submerged in a bioreactor (20). The physical separation of the treated wastewater, namely permeate water from the microorganisms as a result of the treatment procedure realized at high microorganism concentrations in the bioreactor (20) is achieved by the filter group (12) and its continuous automatic control is achieved by the permeate water group (11) and the aeration group (13). Namely, different from the prior art systems, with filtration obtained by using the cloth filter (123) and sludge cake (124) layer, a water effluent having a quality equal to the prior art systems can be obtained.

When evaluated with a general point of view, the submerged filter system (10) subject to the invention composes the biological unit of a whole waste water treatment facility. In domestic wastewater treatment facilities, there exists a physical treatment (screens, grit chamber, pre-sedimentation) before the biological treatment. Additionally, if the removal of biological phosphorus is included in the system, the biological treatment (oxic carbon removal, nitrification, denitrification—nitrification and separation of the treated waste water) is provided after the anaerobic tanks following the physical treatment. In addition to the submerged filter system (10) described above, there are also other units to waste and process the excessive activated sludge accumulated in the system and to dispose it. The proposed system is an important element of this described entirety and it represents the final stage before the discharge to the environment or the recovery of the water.

Under the light of this description, the production may also be done by increasing the number of the submerged filter systems (10) or changing the system's dimensions without affecting its filtration characteristics.

The protection scope of the invention is stated under the attached claims and cannot be restricted to the descriptions given only for demonstration. Because, it is obvious for a person skilled in the art to produce similar embodiments under the light of the description given above without straying from the main idea of the invention.

1. A submerged filter system separating the activated sludge and the permeate water within the waste water with the cake filtration method by being adapted into a bioreactor in a submerged position, characterized in that, it comprises at least one filter group which has a sludge cake layer that separates the activated sludge and the permeate water physically and a cloth filter which contributes to the filtration process by bearing the formation of the said sludge cake.

2. A submerged filter system according to claim 1, characterized in that it comprises at least one filter support pipe which supports the said filter group elements by bearing them.

3. A submerged filter system according to claim 2, characterized in that it comprises holes provided on the said filter support pipe which provides the accumulation and conveying of the filtered water.

4. A submerged filter system according to claim 1, characterized in that it comprises at least one permeate water group which discharges the permeate water provided by the filtration provided by the filter group.

5. A submerged filter system according to claim 4, characterized in that it comprises at least one permeate water pipe which discharges the filtered water by being connected to the filter support pipe at the said permeate group.

6. A submerged filter system according to claim 4 characterized in that it comprises at least one motorized valve which controls the permeate water line by being adapted to the said permeate water pipe.

7. A submerged filter system according to claim 6, characterized in that it comprises at least one flow meter which provides the control of flow rate of the permeate water.

8. A submerged filter system according to claim 4, characterized in that, it comprises at least one pressure transmitter which provides the control of the pressure of the permeate water line.

9. A submerged filter system according to claim 4, characterized in that it comprises at least one manual valve which provides the opening and closing of the permeate water line.

10. A submerged filter system according to claim 1, characterized in that it comprises at least one aeration group which provides the equilibrium of the sludge cake layer and provides the transfer of the air needed for filtration into the bioreactor.

11. A submerged filter system according to claim 10, characterized in that it comprises at least one blower pipe which provides the transfer of the air taken from a blower outside the bioreactor to the diffusers.

12. A submerged filter system according to claim 10, characterized in that it comprises air holes, which keeps the sludge cake layer at the desired equilibrium level.

13. A submerged filter system according to claim 10, characterized in that it comprises at least one diffuser pipe which provides the distribution of the air taken from the blower into the tank in which the filtration process is realized.

14. A submerged filter system according to claim 10, characterized in that it comprises at least one support material which keeps the filter group and the aeration group together.

15. A submerged filter system according to claim 1, characterized in that the cloth filter is substantially made of polyester material.

16. A waste water treatment method by a submerged filter system which separates the activated sludge and the permeate aeration in the waste water by the filtration method by being adapted into a bioreactor in a submerged position, characterized in that it comprises the steps below:
initiation of aeration through the air holes;
opening of motorized valve and the manual valve;
accumulation of the sludge on and around the pores of the cloth filter when the sludge contacts with the cloth filter;
formation of the sludge cake by the sludge layer accumulated on the cloth filter in time; and
obtaining the permeate aeration (treated waste water) at a desired quality as a result of the filtration with the sludge cake layer.

17. A method according to claim 16, characterized in that the steps of initiation of aeration through the air holes and opening of motorized valve and the manual valve steps may be realized simultaneously.
